(19) United States
(12) Patent Application Publication
(10) Pub. No.: US 2004/0177115 A1
(43) Pub. Date: Sep. 9, 2004

(54) System and method for music search and discovery

(76) Inventors: Marc S. Hollander, New City, NY (US); James Davidson, Reston, VA (US); James Ridgeway, Reston, VA (US); Julio L. Hernandez-Miyares, Elizaville, NY (US)

Correspondence Address: GLENN PATENT GROUP, 3475 EDISON WAY, SUITE L, MENLO PARK, CA, 94025, US

(21) Appl. No.: 10/733,835

(22) Filed: Dec. 10, 2003

Related U.S. Application Data
(60) Provisional application No. 60/433,734, filed on Dec. 13, 2002.

(51) Int. Cl. G06F 15/16

(52) U.S. Cl. 709/203

(57) ABSTRACT

The invention provides a comprehensive and integrated music search and discovery tool that allows a user to find music information available from a provider in one place, by song or artist. The preferred embodiment comprises a mega indexer facility for versioning and bouncing of searchable runtime data structures across multiple systems that is atomic at the HTTP connection level. It further comprises a DCI Today platform for integration of a Web server within a client process providing a framework for secure client side Web applications even while off line. Finally, it comprises a server PreQueue for minimizing the overhead associated with waiting for remote resources in a multi-threaded IO model.

### CROSS REFERENCE TO RELATED APPLICATIONS

This application claims priority to U.S. provisional patent application No. 60/433,734, filed Dec. 13, 2002, entitled Music Net, which is incorporated herein in its entirety by this reference thereto.

### FIELD OF THE INVENTION

The invention relates to the search and discovery system and method in a network environment and, more particularly, to a digital music search and discovery system and method.

### BACKGROUND OF THE INVENTION

The Internet is worldwide system of computers and networks. The Internet has millions of users for business, education, entertainment, and/or basic communication. Most of these networks have publicly accessible information. This information includes music, artists, programs, pictures, and the like. These databases and networks house a great deal of information that can benefit those that have the ability to access it. However, existing systems do not adequately provide a seamless delivery to a large number of recipients, nor do such technologies provide a fail-safe seamless playback of content upon failure across the network.

Music Search by Interactive Graphical Specification with Audio Feedback, U.S. Pat. No. 6,528,715, issued to Gargi on Mar. 04, 2003, describes a method and system for creating a musical query. The music query graphically generates a musical segment that represents a portion of a desired piece of music. A user receives audio feedback by playing the music segment. A music query generates based on the music segment. In addition, the graphical generation of the music segment and audio feedback are repeatable until the user acknowledges the acceptability of the music segment. Once the music segment is acceptable, the music query is generated.

Search Method and Apparatus for Locating Digitally Stored Content, such as Visual Images, Music and Sounds, Text, or Software, in Storage Devices on a Computer Network, U.S. Pat. No. 6,445,822, issued to Crill et al. on Sep. 3, 2002, describes a music searching and comparing method. This method allows a user of a software application and computer system to create, identify, select, provide, or otherwise produce one or more reference images for the user to search and compare. This includes searching for, retrieving, or providing one or more candidate images, comparing one or more candidate images; with one or more reference images; and indicating the results of the comparison. The result of the comparison provides a degree of correlation or matching between one or more of the candidate and reference images.

In Search Index for a Music File, U.S. Pat. No. 6,307,139, issued to Iwamura on Oct. 23, 2001, a music file is provided that has a search index and a formatted music data block. The formatted music data block is a complete formatted musical piece. The information in the search index includes a header data block, one or more melody data blocks, a lyrics data block, and an auxiliary data block. The header data block, lyrics data block, and auxiliary data block are plain text data. The melody data block further includes a melody that is in the formatted music data block. The melody data blocks are integer data, American Standard Code for Information Interchange data (ASCII), or Musical Instrument Digital Interface data (MIDI). Each data block in the search index also contains an identifier and a block size. In an alternate embodiment, the block size information is in the header data block. Finally, the search index data block directs the user to the musical piece.

In Music Searching Device with Time Dependent Search Function, U.S. Pat. No. 4,754,346, issued to Takagi et al. on Jun. 28, 1988, there is a music search device for a tape containing a number of pieces of music. If the search begins within a fixed period since the beginning of the currently played piece, the tape jumps back to the beginning of the preceding page. If the search begins after the fixed period, the tape jumps back to the beginning of the current piece of music.

Record Player with Automatic Music Search Function, U.S. Pat. No. 4,528,653, issued to Asano on Jul. 9, 1985, describes a record player equipped with a tone arm control. The tone arm control enables the record player to perform an automatic music search, that is, the pickup device of the tone arm automatically controls being set down at the beginning of a selected song. In one instance, the center of the record displaces slightly from the center of the turntable so that different angular segments of the recorded tracks lie at different radial distances from the turntable center. The tone arm control then compensates for this by detecting the radial and angular position of the beginning of the selected song. The tone arm control then sets down the pickup device at this position. The measurement of the radial position at the beginning of each song is along a radial reference detection line while the turntable is at rest at an initial angular position. Furthermore, while the turntable rotates the tone arm moves across the record until the pickup device reaches the measured radial position at the beginning of the selected song. The tone arm control detects the angular position of the turntable relative to its initial position. The tone arm control then determines the moment to set down so that the record rotates just enough to bring the reference line to the angular position of the pickup device. Consequently, the pickup device is set down at the angular position on the record at the measured radial position at the beginning of the song. The result is that play starts at the beginning of the song even when eccentricity of the record causes the track to be off-center.

Hand Held Electronic Music Encyclopedia with Text and Note Structure Search, U.S. Pat. No. 5,739,451, issued to Winksy et al. on Apr. 14, 1998, a hand-held electronic music reference machine is disclosed, which includes a platform having a keyboard and a display for displaying text. A removable or permanent database mounted to the platform has a memory that stores a multiplicity of songs selected lyrics, title, and identification information. The database has another memory that stores a segment from each of the songs. A user actuates the memory database where the songs are stored for display, permitting the user to select a song from a list of song titles shown on the display. This includes displaying of the lyrics. In addition, the user actuates an audio production element on the platform coupled to the selection component and the database. This enables for the selected song an audible reproduction of the segment stored in the other memory. Search filters allow the user to determine a song title from bits of ancillary information, including a series of relative note or pitch values, i.e., a melody line that is rising, falling or remaining at the same in pitch value.

Method for Editing a Playlist to Read Main Data in a Desired Reproduction Sequence, U.S. Pat. No. 6,542,445, issued to Ijichi et al. on Apr. 1, 2003, describes a method and apparatus for reproducing a plurality of main data recorded on an insertable recording medium. The user accomplishes this in the desired sequence specified by the playlist. The main data records on a record region of the recording medium. The user then selects a playlist that records in a management region of the recording medium.

In Method for Creating, Modifying, and Playing a Custom Playlist, Saved as a Virtual CD, to be Played by a Digital Audio/Visual Actuator Device, U.S. Pat. No. 6,446,080, issued to Van Ryzin et al. on Sep. 3, 2003, a custom playlist is created via a human interface. The custom playlist is played by a digital audio/visual actuator device that is creatable and modifiable through use of an external device such as a personal computer. The tracks, easily identifiable by their track index identifier and the table of contents (TOC) of the digital storage device that stores the tracks, are selectable by the user or by an automated method and added to a playlist file. After creating the playlist file, the playlist file stores to a non-volatile memory of the digital audio/visual actuator device. The playlist then is modifiable by performing such functions as adding tracks, deleting tracks, and rearranging tracks of the playlist through the interface of the external device. The playlist is playable by the digital audio/visual actuator device at any time after creation. Finally, the digital audio/visual actuator device is controllable through a remote control unit to actuate the playlist.

Method and Apparatus for Optimizing a Playlist of Material, U.S. Pat. No. 5,924,071, issued to Morgan et al. on Jul. 13, 1999, a memory is disclosed that has data corresponding to a playlist. The playlist is controllable by an associated circuit that eliminates the problems created during playback by short data segments. The playlist is parsed to determine whether any segments in the playlist fail to exceed a threshold length. Such a segment is copied, along with all or part of the next segment, to create a new virtual segment that exceeds the threshold length. During the playback, the virtual segment replaces the original short segment.

Programmed Jukebox Capable of Calculating a Continuous Updated Playlist, U.S. Pat. No. 5,668,788, issued to Allison on Sep. 16, 1997, describes a system for playing performance recorded on a disc, tape, and records. This system includes video display terminals with a touch panel control for audience selection of particular played performances. The terminals not only list performances, but also the graphics and text on the album covers or disc jacket to enhance the selection process. A computer controller controls the apparatus that stores the recordings, and that selects, manipulates, and plays the various performances selected at the terminals. The controller creates the playlist based on the popularity of each performance indicatable by choices registered at the terminals, with a preset time interval delay before any performance is repeatable. When not used for selecting, the terminals display advertisements, games, and the like.

In Playlist Mechanism for Specification of Complex Memory Objects, U.S. Pat. No. 5,428,731, issued to Hancock et al. on Jun. 27, 1995, multimedia data objects in memory are disclosed that need not be processable serially from beginning to end. The multimedia data objects in memory are definable as algorithmically generated data streams. This functionality is through an architected application-programming interface with a mechanism for defining a method of composing a complex object for smaller objects. This is for defining a behavior of the complex object and for allowing that behavior to be variable based on external events.

In summary, while some content delivery technologies describe the delivery of streamed content across a network, the existing systems do not adequately provide a seamless delivery to a large number of recipients. In addition, these technologies do not provide a fail-safe seamless playback of content upon failure across the network.

Therefore, there is a need to provide a system and method that provides a seamless delivery of songs to a large number of recipients providing a fail-safe seamless playback of content upon failure across the network. The development of these content delivery systems is a major technological advance.

Furthermore, it would also be advantageous to provide a system and method that provides delivery of content as well as metadata to multiple distribution points having the capability of broadcasting content indefinitely, even if a database or content store fails.

### SUMMARY OF THE INVENTION

It is an aspect of this invention to provide a comprehensive and integrated music search and discovery tool that allows a user to find all music information available from a music source, in one place, for example by song or artist.

It is another aspect of this invention to provide the user with a set of tools that allow the user to receive a personalized experience including recommendations that leverage a user's music preferences.

It is yet another aspect of this invention to provide a comprehensive and integrated music search and discovery tool that is implementable for a wide variety of electronic content, such as, songs, dialog, discussion, video content, multimedia content, or any combination thereof.

It is still yet another aspect of this invention to provide a comprehensive and integrated music search and discovery tool in connection with personal computers, mobile devices, portable digital assistants (PDA's), or network enabled cell phones.

It is still yet another aspect of this invention to provide a comprehensive and integrated music search and discovery tool in connection with interaction between one or more user terminals and one or more radio sites, e.g. across as the Internet.

To accomplish these and other aspects of this invention, there is provided a system for music search and discovery. The presently preferred embodiment comprises a comprehensive and integrated music search on-line and a discovery tool that allows a user to find music information available from a music source, such as that provided by America On-line (AOL)™. Such music information is typically available in one place, by song or artist. This includes a mega indexer facility for versioning and bouncing of searchable runtime data structures across multiple systems that is atomic at the hypertext transfer protocol (HTTP) connection level. It further includes a DCI Today platform for integration of a Web server within a client process to provide a framework for secure client side Web applications, even while off line. Finally, it includes a server PreQueue for minimizing the overhead associated with waiting for remote resources in a multi-threaded input/output (IO) model.

A method for music search and discovery provides a comprehensive and integrated music search and discovery tool. This allows a user to find music information available from a music service in one place, by song or artist. It includes the step of engaging a mega indexer facility for versioning and bouncing of searchable runtime data structures across multiple systems that is atomic at the HTTP connection level. Another step includes engaging a DCI Today platform for integration of a web server within a client process providing a framework for secure client side web applications even while off line. A final step includes engaging a server PreQueue for minimizing the overhead associated with waiting for remote resources in a multi-threaded IO model.

### BRIEF DESCRIPTION OF THE DRAWINGS

FIG. 1 is a diagram of the structure of an Internet Uniform Resource Locator;

FIG. 2 is a system organization diagram of the primary components for the invention;

FIG. 3 is a system organization diagram of the primary software components for a preferred embodiment of the invention;

FIG. 4 is a system organization diagram of the primary software components of the Resource Integrator Client for a preferred embodiment of the invention;

FIG. 5 shows servers at the DCI Today platform all sharing a common server PreQueue core and extensions according to the invention; and

FIG. 6 is flow chart of the subscriber process for accessing information resources from an online service and the Internet according to the invention.

### DETAILED DESCRIPTION OF THE INVENTION

While the description of the invention below is provided with reference to the delivery of music, e.g. songs, a practitioner in the art will recognize the principles of the claimed invention are applicable elsewhere. The apparatus and techniques are implementable for a wide variety of electronic content such as a wide variety of audio or other content.

For purposes of the discussion herein, Uniform Resource Locator (URL) is a mechanism for accessing resources on the Internet. Using a URL on the Internet addresses resources such as Hypertext Markup Language (HTML) documents, images, sound files, database search engines, and the like.

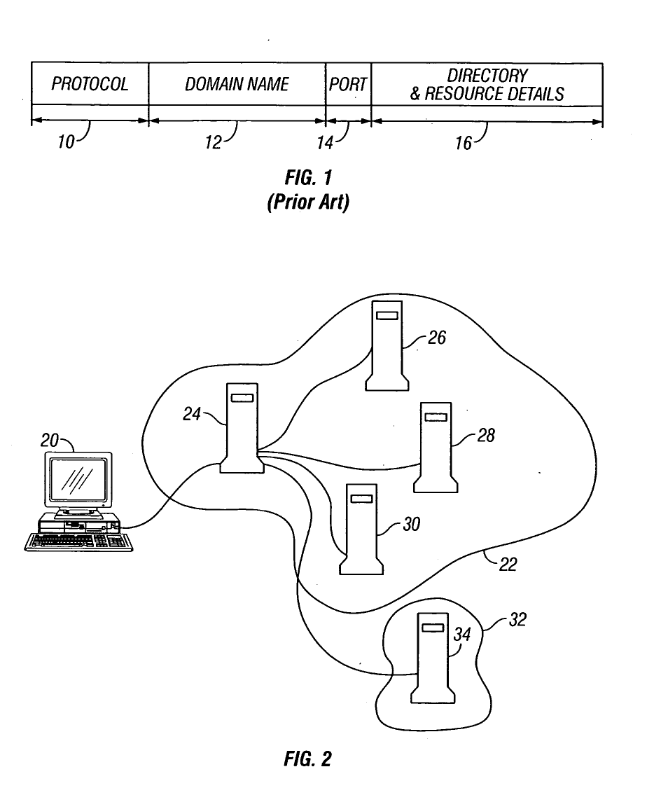

A text string as described herein is a single line of printable ASCII characters that are viewable as an identifier for the resource, which is useable to reference data or any resource on the Internet. FIG. 1 shows a structure of a URL that follows a specific structure and syntax. The first part of the string 10 defines the protocol or scheme in processing the string.

The next field 12 indicates an Internet Domain Name of a site on which a server is running that is capable of processing the request embodied in the URL. For example, the domain name is a plurality of names including but not limited to, http://home.digitalcity.com and www.musicnet.com.

The Port Number 14 is optional. It indicates the port number of the server to which to direct the request. If not present, the browser or client application assumes a commonly understood default value of the indicated protocol.

The last field 16 defines the location of the resources. In many instances, then field 16 supplies a directory structure that leads to a particular file. For example, /path/subpath/file.exe. The location also indicates an application or script and associated search string. For example, /cgi-bin/srch-data?archie +database.

As is known by the practitioner in the art, the URL scheme of the Internet is flexible and adaptable. Each URL indicates a particular access and where to access a resource. The URL access follows well-known conventions and uses different methods. This is so that the information shared between the client and application server is an identifier for the appropriate access method. In addition, the application servers need only information about the hierarch to process a client request.

Within an online service, such as MusicNet™ and Digital City™, resources are viewable as objects, such as playlisting, searching, streaming music, downloading library files, databases, and the like. Although accessible through a proprietary protocol, these same objects are identifiable through extension to the URL (XURL) scheme of the Internet. In addition, the objects of the online service are resources identifiable in accordance with the URL Internet scheme and accessible through the proprietary protocol. The extensions to the URLs (XURLs) facilitate access to the online resources just as standard URLs facilitate access to Internet resources. The system and method of the invention, based upon extensions to URLs, allows online service objects to be accessible in a manner similar to that for accessing Internet resources. The URL extensions, unique to the invention define a uniform resource identification scheme that allows online service subscribers to use a single client application for accessing information resources regardless of their location.

In a preferred embodiment of the invention, the URL extensions are primarily for use as links to objects and the like. The extensions relate to application protocols that support the online service. In other words, the extensions provide a mapping to existing protocols and ensure the information needed for processing the request is according to existing protocols. The XURLs are interpretable by the resource integrator client so that communications are only with server applications that understand the existing protocol.

FIG. 2 shows a system organization diagram of the hardware and associated software components for the preferred embodiment of the invention. Typically, online services 22 include a large number of network node computers 24 and host servers 26, 28, 30 in communication with one another via a wide area network. Online network node computers 24 communicate with the Internet 32 so that users of the Internet connect directly to the online service 22. In addition, they communicate to subscribers 20 of the online service. The subscribers 20 to the online servers access other servers 34 throughout the Internet 32.

The online service subscriber 20 accesses the online service 22 through network node computers 24. The Resource Integrator Client running on the subscriber's computer facilitates the subscriber's interaction through display pages to record the subscriber's selections with servers 26, 28, 30, 32 that provide the requested services. After determining the subscriber's area of interest, that is, music by song or artist, including multimedia clips, videos, artist features, photos, and the like, the subscriber retrieves content pages related to their interest. The resource integrator is capable of determining, based on URLs or XURLs, whether a content page is displayable. This is in accordance with an online service protocol, which is an Internet protocol, an existing proprietary protocol or Web browser. In other words, the URLs and the XURLs specify the communication requirements, that is, the Internet or an existing proprietary protocol, between the Resource Integrator Client and server application software.

The Resource Integrator Client and server application software conforms to specifications and conventions for usage with Web products. The subscriber interacts with the Resource Integrator Client 20 that communicates with the online resource integrator servers 26, 28 through the HTTP protocol of the Internet. Initially, the subscriber's interactions are with resource integrator pages. These are Web pages with which the subscriber interacts in communicating information regarding the subscriber's tasks, requests, and/or actions. In addition, displays may be resource integrator pages from the online service that facilitate the determination of the subscriber's actions, 26, 28, Web content pages from other Internet Web sites 32, or content pages.

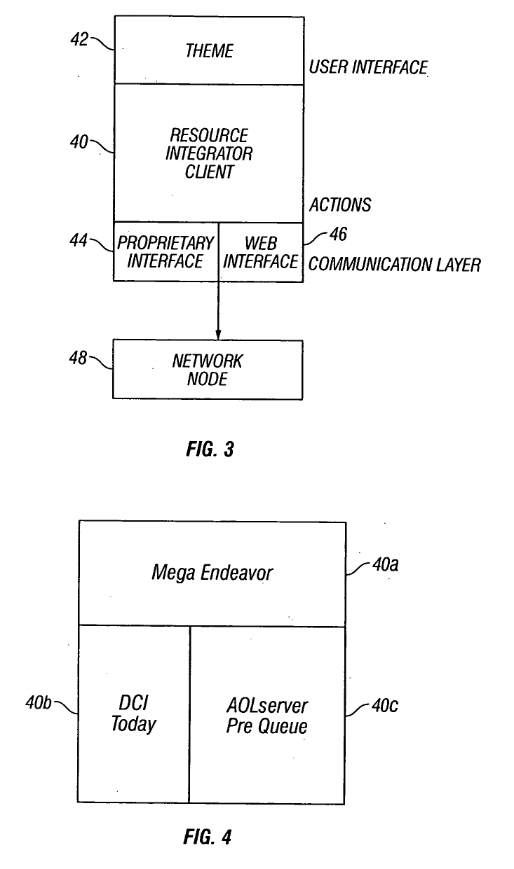

FIG. 3 shows a system organization diagram of the primary software components for a preferred embodiment of the invention. The Resource Integrator Client 40 manages the interactions between the subscriber and the servers of the online service and the Internet through a network node computer 48. Various user interface themes 42 are implementable on top of the Resource Integrator Client 40 so that the subscribers choose a particular style of interface for interacting with the online service. The Resource Integrator Client 40 manages communications with the online service using both a proprietary interface existing protocol 44 and a Web interface HTTP protocol 46.

FIG. 4 shows a system organization diagram of the primary software components of the Resource Integrator Client 40 for a preferred embodiment of the invention. The primary software components are the Mega Indexer platform 40a, the DCI Today platform 40b and the server PreQueue platform 40c. All information resources are locatable using a URL or a XURL and are interfaceable to each other. The URLs and XURLs point to content pages inside and outside the online service. Then identifiers interpret table pages to locate the desired content. The transformation of a requested URL or XURL to actual content is invisible so the subscriber does not directly use the URLs or XURLs. The URL format does not imply a specific means by which the requested content is stored on the server nor does it exclude specific server storage mechanisms.

The Resource Integrator Client 40 and server application software communicate through HTTP. This is because the client application software uses Web pages to facilitate a subscriber's interaction in locating online service and Internet based information. In addition to using HTTP in the preferred embodiment of the invention, using the Common Gateway Interface (CGI) scheme of Web-based products retrieves appropriate Resource Integrator pages. The CGI allows the HTTP server processing requests for the Resource Integrator Client 40 to activate additional programs and perform additional processing on data from the client or other sources.

The Mega Indexer platform 40a is a facility for versioning and bouncing or searchable runtime data structures across multiple systems. This is accomplishable at the HTTP connection level. The Mega Indexer platform 40a bounces large data structures into a running multi-read process with no lock contention that is completely safe, and in an atomic manner within the scope of the HTTP connection. The Mega Indexer platform 40a uses the standard k-d tree and delauney triangulation algorithms. However, the platform extends it's functionality for bounded searches and leg weighting to “n nearest neighbors” in two dimensions that changes direction of the search towards or away from clusters.

The DCI Today platform 40b integrates a Web server within the Resource Integrator Client 40 process providing a framework for securing client side Web applications, even while offline. The client application embeds a fully functional Web application server in the process. The preferred DCI Today platform includes over 6000 ADP templates with over 170,000 lines of HTML and Tcl, over 100,000 lines of Tcl in addition to over 800 library files. In addition, there are over 3000 Tcl procs and over 450 C functions, with about 280 implement Tcl commands. Finally, there are multiple SQL/PLS databases with over 1 million records.

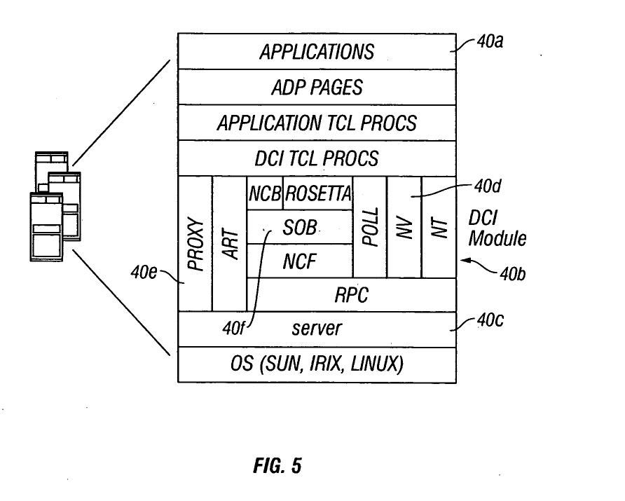

FIG. 5 shows that servers at the DCI Today platform 40b all share a common server PreQueue core and extensions. For example, within the DCT Today platform 40b is the network variable (NV) 40d, the proxy 40e and the small object (SOB) 40f. The NV 40d is an extension of the network-shared variable (nsv) in the server PreQueue. This allows a subscriber, that is, a front-end server, to request streaming updates from a backend server. The Tcl templates access data NV array without regard to underlying network updates:

<html>
Current Music:
<%= [nv.get music current] %>
...

The proxy 40e interface is a modified Tcl-shell capable of communicating through pipes with the server PreQueue. The processes fork on demand and maintained in a pool, wherein pools initialize with application-specific startup scripts. The proxy interface isolates code that is not thread safe and evaluates code that fiddles with env, that is, env(TZ). The scripts are sendable to proxy with proxy.send:

```
<html>
  Search Results:
  <%
    set script ”pls.search $query”
    foreach doc [proxy.send db $script] {
      ns_adp_puts [putheadline $doc]
    }
  %>
  ...
```

Finally, the SOB 40f is a highly optimized client/server interface. This allows access through pools of persistent socket connections with aggressive caching and optimized I/O. The SOB 40f is a critical platform component used for dynamic publishing of music content, storage of meta data for various service areas and for fetch and post data. The subscriber requests music, wherein the template ignores the complexity and simply executes:

<html>
Music:
<%= [nsob.get musicid] %>
...

The DCI Today 40b extensions provide a powerful set of interfaces and API's for server PreQuene 40c and Mega Indexer 40a. For Example, the DCI Today provides subscribers with music listed by artist or song, including multimedia clips, videos, artist features, photos, and the like in any media setting. In addition, there is a set of tools allowing subscribers to receive a personalized experience. This includes recommendations that leverage the subscriber's music preferences. For example, when a subscriber hits particular content they may want to find more like it, bookmark it, save it, and the like or generate a playlist.

Again, referring to FIG. 5, the server PreQueue 40c is a single pre-threaded event based input/output (IO) blended with multi-threaded Web page execution. It minimizes overhead associated with waiting for remote resources in a multi-threaded IO model. It is a full featured, multi-threaded Web application environment. In addition to static page serving and CGI's, the server PreQueue includes a rich and flexible C application program interface (API) for dynamically loading user-written C Modules (DLL's), structured query language (SQL) database services and binding functions to arbitrary Web requests. However, a useful aspect of server PreQueue is its complete tool common language (Tcl) integration. The Tcl integration provides Tcl command interface to the underlying C API. The Tcl commands handle URL requests, query a database and the like. For example, in the preferred embodiment of the invention ns_db is useable to access an SQL database:

```
proc getMusic {} {
    set page ”<html><body>\nCurrent Music: \n”
    set db [ns_db gethandle musicdb]
    set row [ns_db select $db “select * from music”]
    while {[ns_db getrow $db $row]} {
      append page ”[ns_set get $row music] <br>\n”
    }
    append page ”</body></html>”
    ns_set free $row
    ns_db releasehandle $db
    ns_return 200 text/html $page
}
```

The server PreQueue provides a multi-threaded Tcl environment where more than one thread of execution is active in the program. This allows simultaneous access to memory, database files and the like. For example, a subscriber searching Musicnet™ database files for music containing a specific melody can simultaneously search other identifiable databases for music with similar melodies, thereby generating a playlist. Other applications include, but are not limited to user profiles, stream and download metadata, and audio content. The use of multi-threads in the sever PreQueue increases throughput by running simultaneously on separate computer processing units. The uses of threads provides faster access to expensive shared resources, such as a large cache. The server PreQueue provides a seamless multi-threaded interpreter initialization. It uses a pool of pre-initialized interps, direct linking of select parts of the interp structure and cloning of a single master interp for later interps. At startup, the pre-initialized interps initialize and put into the pool. When needed, the threads then allocate from the pool and the thread returns the interp when done. The pooling limits locking, provides high performance, share variable requiring a command interface (ns_var) and allow for threads to backup waiting for interps. In cloning at startup, a single master interp initializes a command and variable table. After startup, there is creation of new interps and then updating of the interps by copying the commands and variables from the master. There is limited locking and high performance. For example, threads are creatable and join with ns_thread:

```
Proc my.thread {host} {
    ... open socket, fetch page
}
foreach host {host 1 host 2 host 3 host 4} {
    lappend tids [ns_thread begin “my.thread $host”]
}
foreach tid $tids {ns_thread wait $tid}
```

The combination of the Mega Indexer platform, the DCI Today platform and the server PreQueue allows a comprehensive and integrated search, music discovery, and a music toolbox. This includes, but is not limited to, contextually relevant information such as multimedia, videos, photos discography and lyrics, or any combination thereof. It provides consistent and easy navigation of results that allows a threaded community, commerce, and recirculation. Furthermore, the comprehensible and integrated search is extensible to Web properties. The music discovery enables subscribers to receive a personalized experience, including recommendations that leverage a subscriber's music preferences. In addition, the music toolbox is a core of set of tools that are available in any media setting including, but not limited to media player and radio. For example, where a subscriber hits particular content they may want to find more like it, bookmark it or save it, and the like.

FIG. 5 shows servers at DCI Today all share a common server PreQueue core and extensions.

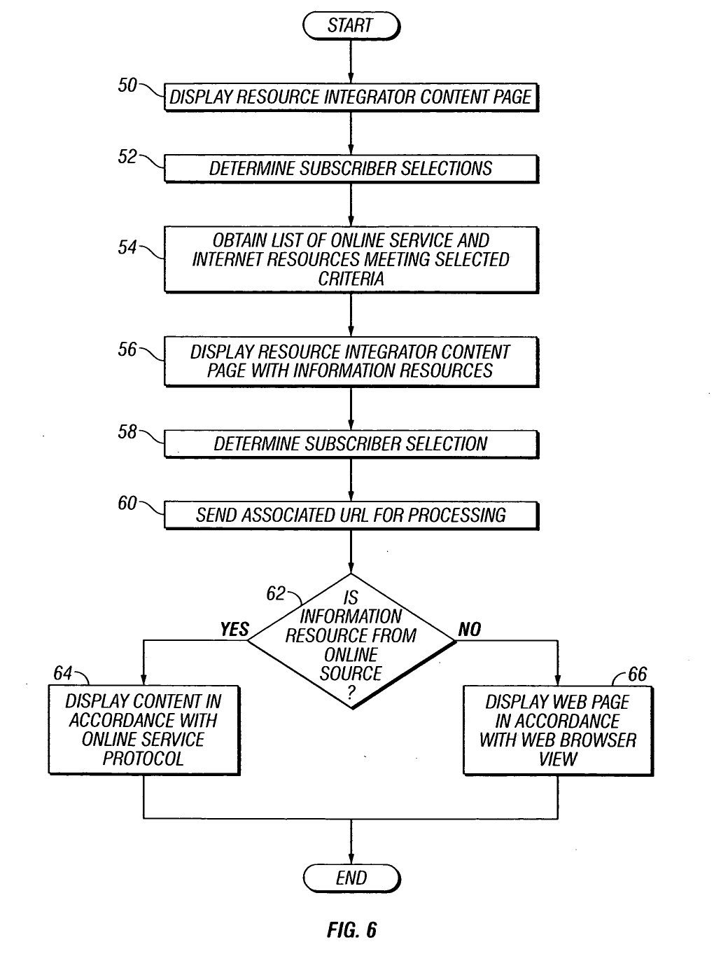

FIG. 6 shows a flow chart of the subscriber process for accessing information resources from an online service and the Internet. A Resource Integrator page is displayable by the Resource Integrator Client to the subscriber 50 so that the subscriber makes selections regarding music topics and actions of interest 52. The subscriber interacts with several pages before determining all selections. Following the subscriber selections, the Resource Integrator Client server creates a list of online service and Internet resources that meet the selected criteria 54. This occurs through the Mega Indexer platform, the DCI Today platform, and server PreQueue platform.

The options that meet the selected criteria are associatable with URLs or XURLs. Another Resource Integrator page displays the results of the subscriber 56. The subscriber then makes a selection from the list of options 58. The URL or XURL in association with the selection is sendable to the server for processing 60. The Resource Integrator Client looks 62 at the URL to determine whether the retrieved content page is displayable if in accordance with an online service protocol or Web browser. The ability of the Resource Integrator Client to manage the presentation of information from either source provides the seamless integration of online service and Internet resources.

Referring to FIGS. 1 through 5, a method for music search and discovery provides a comprehensive and integrated music search and discovery tool. This allows a user to find music information available from an on-line music provider such as AOL music, in one place, by song or artist. It includes the step of engaging a mega indexer facility for versioning and bouncing of searchable runtime data structures across multiple systems that is atomic at the HTTP connection level. Another step includes engaging a DCI Today platform for integration of a Web server within a client process providing a framework for secure client side Web applications, even while off line. A final step includes engaging a server PreQueue for minimizing the overhead associated with waiting for remote resources in a multi-threaded IO model.

While there was illustrated and described what is at present considered the preferred embodiment of the claimed invention, it is appreciatable that numerous changes and modifications are likely to occur to those skilled in the art. It is intended in the appended claims to cover all those changes and modifications that fall within the spirit and scope of the claimed invention.

1. A comprehensive and integrated music search and discovery tool for allowing a user to find music information available from a music service in one place, by any of song or artist, comprising:
a mega indexer platform for versioning and bouncing of searchable runtime data structures across multiple systems that is atomic at the HTTP connection level;
a DCI Today platform for integration of a Web server within a client process to provide a framework for secure client side Web applications, even while off line; and
a server PreQueue platform to minimize overhead associated with waiting for remote resources in a multi-threaded IO model.

2. The system of claim 1, further comprising:
a music toolbox.

3. The system of claim 2, wherein said comprehensive music search and discovery is implementable for a plurality of electronic content.

4. A method that provides a comprehensive and integrated music search and discovery tool for allowing a user to find music information available from a music service in one place, by any of song or artist, comprising the steps of:
engaging a mega indexer facility for versioning and bouncing of searchable runtime data structures across multiple systems that is atomic at the HTTP connection level;
engaging a DCI Today platform for integration of a Web server within a client process to provide a framework for secure client side Web applications, even while off line; and
engaging a server PreQueue to minimize overhead associated with waiting for remote resources in a multi-threaded IO model.

5. The method of claim 4, further comprising the step of:
providing a music toolbox.

6. The method of claim 4, wherein said comprehensive music search and discovery is implementable for a plurality of electronic content.
